(19) United States
(12) Patent Application Publication
(10) Pub. No.: US 2016/0063488 A1
(43) Pub. Date: Mar. 3, 2016

(54) Liquidation system for cash and fixed-asset donations

(71) Applicant: iDonate Liquidation, LLC, Dallas, TX (US)

(72) Inventors: Raymond Gary, JR., Dallas, TX (US); Steven Kravit, Plano, CA (US)

(21) Appl. No.: 14/936,285

(22) Filed: Nov. 9, 2015

Related U.S. Application Data
(63) Continuation-in-part of application No. 14/751,554, filed on Jun. 26, 2015.
(60) Provisional application No. 62/017,989, filed on Jun. 27, 2014.

(51) Int. Cl. G06Q 20/38; G06Q 30/02

(52) U.S. Cl. CPC G06Q 20/38; G06Q 30/0278

(57) ABSTRACT

A system and method of processing, within a single procedure, cash equivalents and fix assets from any disposition class. The method includes identifying the benefactor and asset to be donation. Once identified, the asset is classified into one of three disposition classes. The disposition classes are used to determine the value for valuing. Once the value is determined, an impact statement is generated. Depending on the disposition class, the item is either converted to funds directly or through an intermediary. Once the item is converted to funds, the funds are transferred to the identified benefactor.

### CROSS-REFERENCE TO RELATED APPLICATIONS

The present application is a continuation-in-part of U.S. patent application Ser. No. 14/751,554 filed on Jun. 26, 2015 and entitled “Discerning Cash and Fixed Asset Donations,” which claims priority to Provisional Application Ser. No. 62/017,989 filed on Jun. 27, 2014 and entitled “Discerning Cash and Fixed Asset Donations,” the entire disclosures of which are both hereby incorporated by reference in their entirety.

### FIELD OF INVENTION

The embodiments describe herein are related to a system and method of accepting and processing a variety of types of donations within one system.

### BACKGROUND

The embodiments described herein are a useful and novel method for enabling a single system to accept cash equivalents, brokered fixed assets and lead generation assets in a single online forum.

Unified Class. Systems and inventions in the prior art focus on the collection and processing of a unified class of assets. For example, there is a substantial body of art related to the donation of life insurance policies to institutions. While the exact terms of the donated insurance policies will vary widely, and unpredictably, the systems are able to uniformly handle the entire asset class. They do not present or handle assets such as business ownership or motorized vehicles.

Alternative cash donation option. An alternative for processing fixed assets and cash is to provide a would-be buyer the option of skipping the fixed asset purchase and instead provide a cash contribution to the charity the buyer had selected. In this system, the buyer goes to a classified or auction online site and conducts a search. The search leads the buyer to a list of items meeting the search requirements. Those search requirements may include the name of a charity the buyer has selected. If the buyer decides to purchase an item, a portion of the sale is given to the charity. The funds either originate from the buyer or the website's transaction manager. If the buyer is unable to find something to purchase, an item's description gives the buyer the option to make a cash contribution to the charity listed in their original item search. The somewhat improbable business model is to turn funds a shopper planned to use for a specific purpose into an unplanned donation.

Non-cash assets are all treated identically. These systems make little attempt to identify the asset class. The system is unable to value the item and relies on the honor system for tax reporting. The final collection of fixed assets is completed manually. While these types of systems are known in the industry, their relative lack of sophistication makes full automation impossible.

Multiple systems. Processing institutional gifting of both cash and fixed assets currently requires a combination of an ATM, retail point-of-sale system, title management software, and logistics planning systems. Integrating these systems if often limited by outside concerns, such as discussed in the next section, but the necessary complexity in a diverse asset donation system limits the scope of the practical functionality.

Multiple entities. In addition to requiring multiple systems, current entities that accept both cash and fixed assets have separate legal entities to handle the charitable funds and the non-charitable funds from sale of asset. Since not the all funds from the sale of the asset are for a charitable institution, the sale must also involve a for-profit legal entity. Cash would be distributed to one charitable entity and the funds for the sale of assets are distributed through a for-profit and then to the seller. For instance, at eBay, the entire fund from the sale of the asset is distributed back to the seller through their for-profit PayPal. The seller then later receives a notice that they need to transfer a portion of those funds to the charitable institution. This second transfer is executed through an independent nonprofit organization associated with eBay. The result is a complex set of separate systems and institutions.

The embodiments described below addresses these abating factors.

### SUMMARY OF THE INVENTION

The embodiments below are directed to systems and methods to convert all donated assets to transferable funds before presentation of the donation to the charity.

Accordingly, several objects and advantages of the described embodiments are:

a) to provide donors with one site to handle any type of preferred donation;

b) to provide donors with one site to donate to multiple charities;

c) to provide donors with a list of additional suggested asset from different asset classes;

d) to provide a cash conversion donation of a physical asset;

e) to provide a cash conversion, in a single system, for any type of asset; and

f) to provide liquidators access to only items they wish to broker.

### BRIEF DESCRIPTION OF THE DRAWINGS

The accompanying drawings, which are incorporated in and constitute a part of this specification, illustrate the embodiments and together with the corresponding description.

FIG. 1A illustrates a process that takes place in an integrated donation system that converts cash and fixed assets into settled funds.

FIG. 1B illustrates the process of the integrated donation system of FIG. 1A specifically highlighting the process for handling cash equivalents. For comparison, inapplicable steps for handling other asset classes have been removed.

FIG. 1C illustrates the process of the integrated donation system of FIG. 1A specifically highlighting the process for handling brokered fixed assets. For comparison, inapplicable steps for handling other asset classes have been removed.

FIG. 1D illustrates the process of the integrated donation system of FIG. 1A specifically highlighting the process for handling lead generation fixed assets. For comparison, inapplicable steps for handing other asset classes have been removed.

FIG. 1E illustrates expanded features of the process of the integrated donation system shown in FIG. 1A specifically directed to communication with parties to the donation.

FIG. 2 illustrates a process for classifying an item to determine a particular processing path within the integrated donation system.

FIG. 3 illustrates an example computer system that may be used to carry out the integrated donation system.

FIG. 4 illustrates example interactions between donor, benefactor, and integrated donation computer systems.

### DETAILED DESCRIPTION

Referring to the drawings, in which like numerals represent like elements,

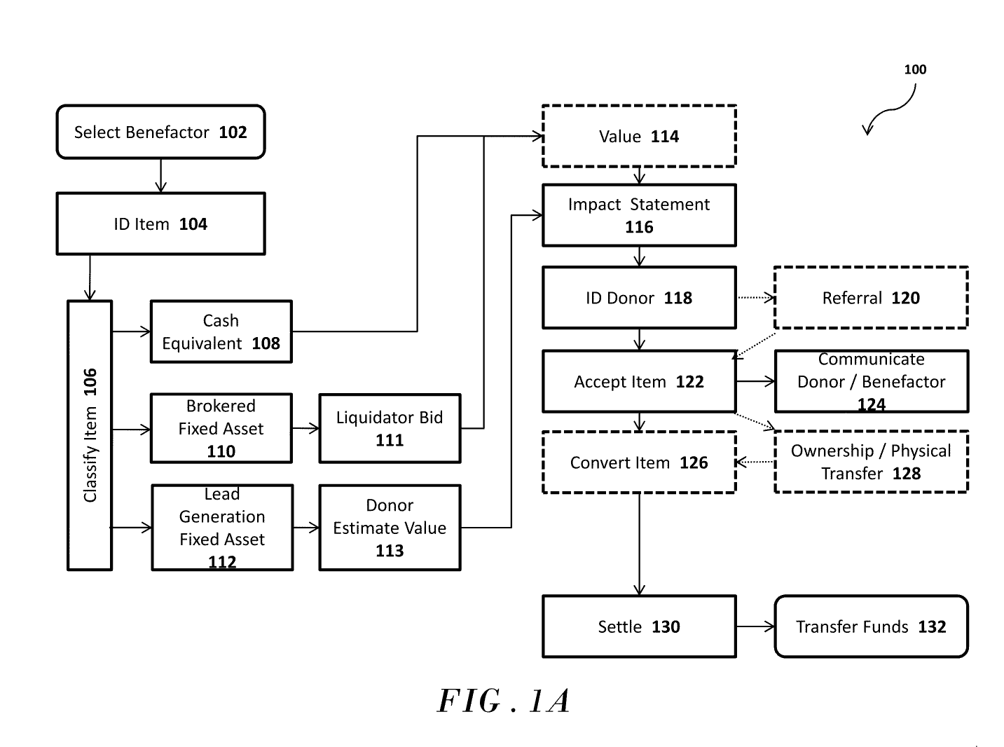

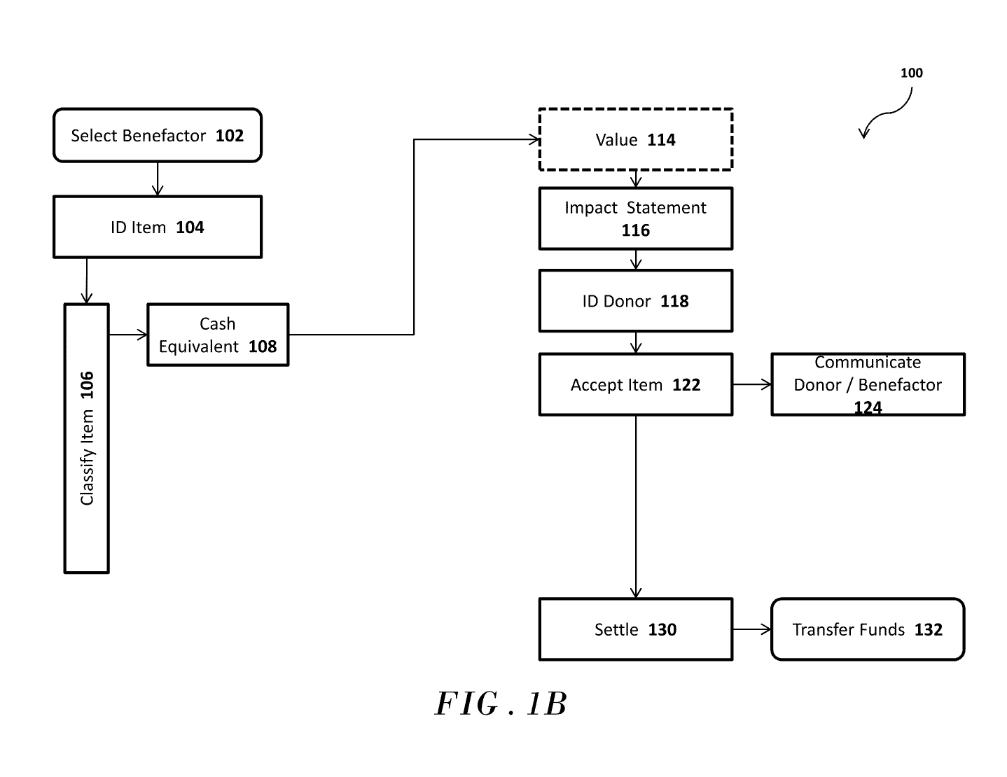

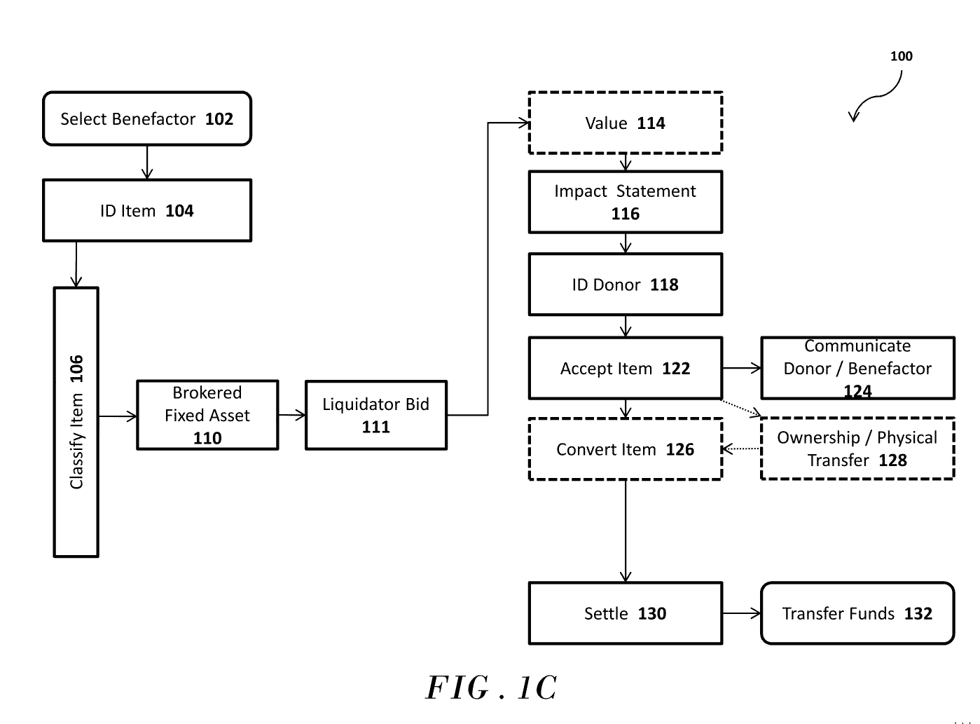

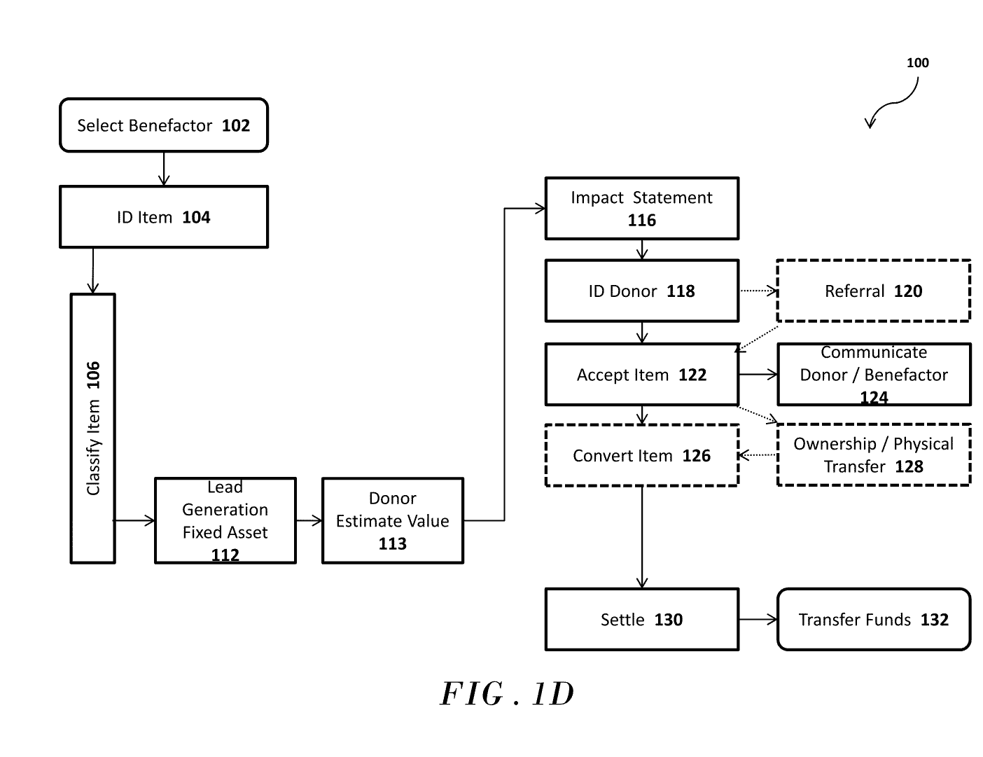

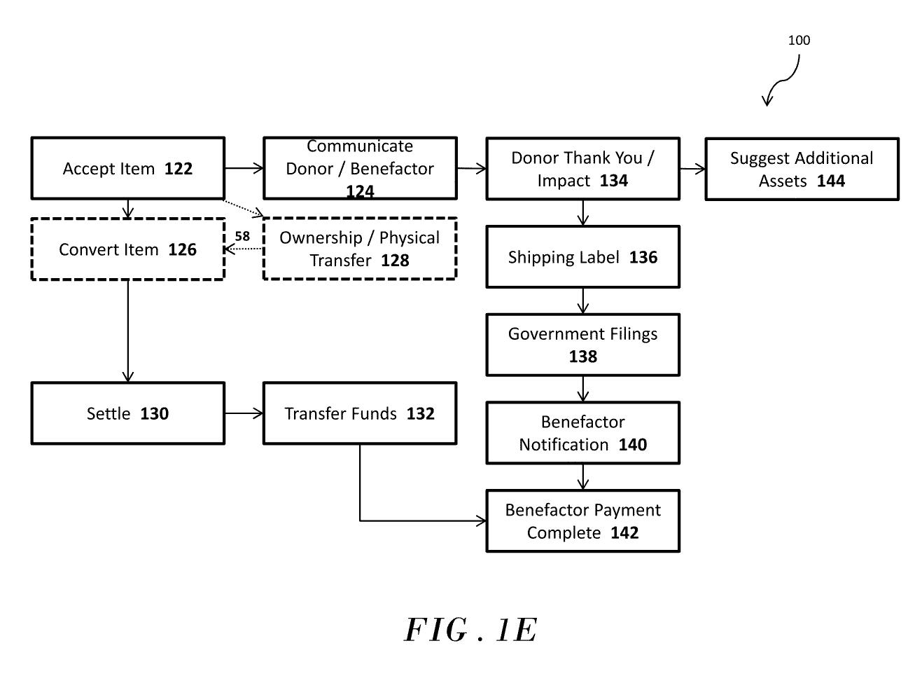

FIG. 1A illustrates a process 100 that takes place in an integrated donation system that converts cash and fixed assets into settled funds. The process may be performed from the perspective of a donor that is identified to the system by a donor ID. First, in step 102, the donor selects a benefactor. The benefactor may be any type of nonprofit entity including a charity, cause, public institution, government entity, fund, individual, private entity, account, or crowdfunding campaign.

Once the benefactor is selected, the donor must then identify the item they wish to donate in step 104. The item may be any type of tangible or intangible asset such as electronic items, cash equivalents, professional service, insurance, or a business ownership. The item is identified to the system any number of user input methods such as, for example, keying an alphanumeric description, keying an item description with predictive text provided by the system, keying a search into the system and selecting from the results, scanning a barcode, selecting from a series of hierarchical drop down boxes, graphical controls, image capture, motion detection, multimodal interaction, electronic pen, touch input, speech synthesis, face input, voice entry, electroencephalography systems, or any combination of the above. Once the item is identified, the system may associate it with a unique identifier.

In some examples, selecting a benefactor in step 102 and identifying an item in step 104 are performed by a user accessing a user interface of a donor computer system (e.g., a desktop, laptop, mobile device, and so forth). The donor system may, for example, display a web interface or other interface that provides the user with the options that may be selected. For example, the interface may be provided by a website, embedded code within a website, or application software that causes the donor computer system to perform the selection and/or identification tasks. In some examples, the system receives the selections and identifications from the donor at a backend server system. The backend server may receive the selections and identifications via a network connection. For example, the donor computer system may connect to the backend server via the network connection and utilize one or more application programming interfaces (APIs) provided by the backend server to communicate with the backend server. In some examples, the backend server is configured as a web server and/or database server that receives information from the donor computer system using the APIs.

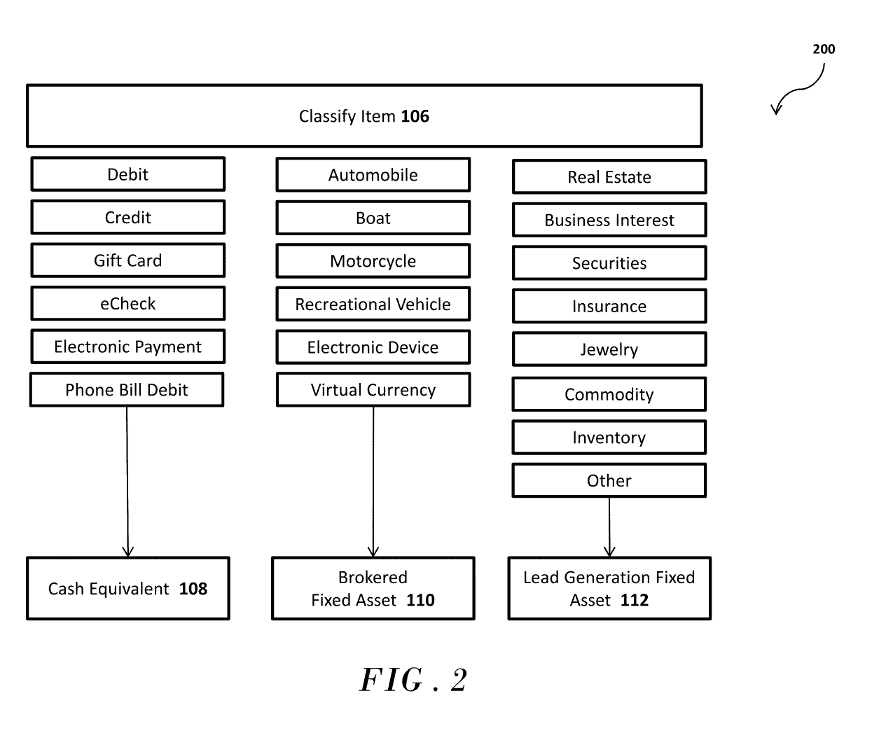

Once the donor selects the benefactor and identifies the item to the system, the system (e.g., at a backend server) then uses the identification of the item to determine the item's disposition class in step 106. The disposition class may be based on item description stored in a database local or remote to the system. The disposition class may also be derived by the system using one or more keywords from the item description. For example, the one or more keywords may be matched with stored descriptions to identify stored descriptions that are similar, and classify the item description to match the similar stored descriptions. Additionally, the donor may supply a classification with the item identification which the system could then verify against the item description and use as the classification. Disposition classes include cash equivalents 108, brokered fixed assets 110, and lead generation fixed assets 112. Examples of assets in each class are described in detail below in reference to FIG. 2. An item's disposition class determines the processing path that it will take through the system in order to be converted to cash. Each specific path is described for each class in more detail in reference to FIGS. 1B-D.

The donor system associates a plurality of identifiers with the item. For example, the backend server may associate the following identifiers with the item using one or more databases: item description, campaign, designation, frequency, schedule, tracking number, organization, unique transaction identifier, status, and so forth.

The item description includes keywords that describe the item. For example, if the item is a car, the item description may include the manufacturer, make, model, model year, mileage, and so forth.

The campaign identifier allows the item to be associated with a particular campaign. For example, an item may be assigned to a particular campaign, such that the donation is associated with and aggregated with other donations that are assigned to that campaign.

The designation identifier may be used to specify a particular benefactor (e.g., charity) to receive the proceeds of the donation.

The frequency identifier may be used to specify a frequency of a donation and the schedule identifier may associate the re-occurring donations with a same donation. For example, a donor of a cash equivalent may specify that the donation is to re-occur on a bi-weekly, monthly or yearly basis according to a particular schedule. The re-occurring donations corresponding to the donation may share the same schedule identifier, which associates the re-occurring donations with the same donation.

The tracking number may be used by the donor to track their donation at various steps of the process. For example, a donor may input the tracking number at a website via a donor device, and in response, the system (e.g., the backend server) may look up the status of the donation in the database and provide the status to the donor device, which presents the status to the donor.

The organization identifier may be used to assign the donation to a particular organization, such that the donation is associated with that organization. For example, employees of the organization may make donations and assign those donations to the organization such that the total amount of proceeds raised by employees of the organization may be tracked.

The unique transaction identifier may be used by the backend server to associate the identifiers with the particular transaction for the donation. For example, a donor may input a particular item to donate. The transaction for processing the donation may be assigned a unique transaction identifier. The transaction identifier may be used by the system to, for example, perform lookups responsive to donor status requests. The transaction identifier may also be used by the system to manage the transaction by accessing the transaction identifier during the transaction to update the various identifiers associated with the item and the transaction.

The status identifier identifies the status of the transaction at different stages of the transaction. For example, the transaction identifier may default to a pending state, but later may be updated by the backend server to an approved state, a transferred state, a sold state, a completed state, and so forth, depending upon the stage of the transaction.

In some examples, identifiers are provided by donors. For example, a donor may specify the particular organization and campaign with which to associate the donation, as well as the frequency of the donation. In other examples, the identifiers are provided automatically by code/instructions stored in the web interface used by the donors. For example, a charity may include the donation interface in embedded code on its website with particular campaign and/or designation identifier, such that a donor using that website will automatically have the campaign and designation identifiers provided. In some examples, identifiers are generated on the backend server. For example, the backend server may generate the unique transaction identifier, status of the transaction, and tracking number.

Regardless of item classification, an impact statement is generated for each item in step 116. The impact statement is based on a benefactor provided metric that converts the value of the item into the amount of assistance the benefactor will receive from the donation. The system (e.g., at the backend server) uses the item's value derived in step 114 to calculate an impact statement. To generate an impact statement for a particular item, beneficiaries provide the system with metrics that indicate how the donated item will provide tangible benefits for the beneficiary. Examples of benefactor provided metrics are as follows:

$8.32 provides one temporary shelter for the beneficiary Red Cross;

$27.32 buys one family a week of food for the beneficiary The Pantry;

$12.00 supplies one pet with food, shelter, and care for the beneficiary Humane Society;

$50.00 will produce 12 finished products for a beneficiary startup.

Based on these and other provided metrics as well as the donated item value, the system determines impact statement for the item. For example, for an item valued at a $100, the system may generate the following impact statements:

12 temporary shelters;

4 families a week of food;

8 pet with food, shelter, and care;

24 finished products for a startup.

The impact statement may be provided to the donor computer system by the backend server and presented on the donor computer system. The backend server may, for example, determine the beneficiary metrics to utilize based on the designation identifier (which identifies one or more benefactors) associated with the transaction. The impact statement helps the donor understand the importance of the donation and encourages completion of the donation process. The impact statement may be provided to the donor upon determination, after the item is accepted, or after the donation process. The impact statement may be written as above, for example, or may use one or more icons to represent each portion of the statement.

Process 100 is discussed in more detail below for each disposition class in reference to FIGS. 1B-D.

The donation system may generate communications at each step that are transmitted to the donor. For example, a backend server may automatically generate and email, text, or other communication at each step in the process to notify a donor as to the status of the donation transaction. For example, each time the status identifier is updated, an electronic communication to the donor may be triggered.

FIG. 1B illustrates the process of the integrated donation system of FIG. 1A specifically highlighting the steps for handling cash equivalents. For comparison, steps in the process that do not apply to items classified as cash equivalents have been removed. As discussed in FIG. 1A, donated items are classified as one of three types. One particular type is cash equivalent item 108. Cash equivalent items include credit or credit card transactions, debit or debit card transactions, gift cards with a cash balance, electronic checks such as, for example, any electronic payment such as automatic clearing house (ACH), or payments derived from other billing services such as, for example, a mobile phone bill.

Once an item is identified as a cash equivalent, the system moves to process by assigning a value in step 114. Cash equivalents may be valued both as a gross donation and a net donation amount. Cash equivalent formats, such as credit versus debit, each have unique fees. For example, while all cash equivalent items valued at a $100 U.S. would all have the same gross value, each particular cash equivalent item would have a different net donation amount based on necessary fees. Additionally, a donor may also specify a frequency of the donation, which may be aggregated for the purpose of generating an impact statement. An impact statement is then generated for the item in step 116. Determining an impact statement is discussed above in reference to FIG. 1A. For cash equivalents that have a frequency, such as monthly or yearly, the donations may be aggregated such that the impact statement is based upon the aggregate value of the donation. For example, a donor may specify that a donation of $100 is to re-occur on a monthly basis for one year. The donation may thus be considered as a $1,200 donation for the purposes of the generated impact statement.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the identification of the donor is complete, the system accepts the item in step 122. For cash equivalents, each specific type of asset involves different processes based on the item description. In particular, for debit and credit transactions, the system makes a charge to the donor's associated account. For an electronic payment, such as a wire transfer, the system sends instructions to the donor's indicated account manager. For gift card transactions, the donor's authorization is submitted to a gift card processor with electronic instructions to transfer the amount to the system's settlement account. There may be separate processing engines (e.g., at the backend server) for processing one-time cash equivalent donations and re-occurring cash equivalent donations. For example, one-time donations may be processed by charging the donor's associated account. Re-occurring donations may be processed by charging the donor's account and utilizing a scheduling engine to schedule future account withdrawals according to the frequency identifier. The re-occurring donations may share a common schedule identifier, but each donation of the re-occurring donations may each be assigned a unique transaction identifier. The scheduling engine may automatically process the re-occurring donations based upon the schedule. For example, each day the scheduling engine may determine which re-occurring donations are scheduled for that day, and automatically charge the appropriate donor accounts corresponding to the re-occurring donations without requiring additional donor input or other user input. These are merely provided as examples and are not intended to limit the described embodiments.

While cash equivalent items have the perception of being highly liquid, they may actually take several days to several weeks before their donation process is complete. For cash equivalents, the backend server may also set a status identifier corresponding to the transaction to “complete” upon receiving authorization from the donor to transfer the funds from the donor, without waiting for the funds to be received. In some examples, the donor's financial institution may suspend transferring funds to the beneficiary until the institution's settlement process is complete. In this case, the system may float the funds to the beneficiary before the transaction is actually settled by the financial institution.

The acceptance step 122 completes the necessary data to provide substantive communications to the donor, the beneficiary, and any necessary reporting agencies. The system then proceeds to communicate any information about the donation, which is discussed in more detail below, in reference to FIG. 1E.

FIG. 1C illustrates the process of the integrated donation system of FIG. 1A specifically highlighting the process for handling brokered fixed assets. For comparison, steps not required in processing brokered fixed assets have been removed. As discussed in FIG. 1A, donated items are classified as one of three types. One particular type is brokered fixed assets 110. Brokered fixed assets include automobiles, boats, motorcycles, recreational vehicles, electronic devices or virtual currency. This list is provided only as an example and is not meant to be limiting.

Once an item is classified as a brokered fixed asset, a liquidator bid is generated in step 111. In some examples, the liquidator bid is referred to as a value assessment. The system (e.g., the backend server) may set the status identifier to “pending” for the transaction while waiting for the liquidator bid. To generate a liquidator bid, the backend server may send a request to a liquidator, which in some examples is a retail network or an auction house. The request may be sent either automatically upon receiving the description of the item, or based on input of a user of the backend server. For example, if the brokered fixed asset is an automobile, the backend server may compare mileage and model year with pre-configured thresholds. If the vehicle exceeds one or both thresholds, the request may be sent to an auction house, otherwise the request may be sent to the retail network (e.g., a network of automobile dealers). In another example, a user of the backend server may receive a notification regarding the pending transaction, and review the brokered fixed asset to make a manual determination regarding whether to send the request to the auction house or the retail network. In addition, the backend server may specify a minimum acceptable bid that is sent to the auction house. In some examples, the minimum bid is set by a user of the backend system. In other examples, the backend system queries one or more database to determine an appropriate minimum bid based on the description of the item (e.g., make, model, mileage, model year, condition and so forth).

Upon receiving the request, the liquidator may examine the description of the item, for example, electronically by matching the description provided by the donor to a database maintained by the liquidator. The liquidator may then generate a bid. The bid represents the value the liquidator is willing to pay for the item. Once received, the bid is recorded and used as the base of the item's value. In step 114, the value of the item may be adjusted based on any required fees, such as liquidator fees or fees charged by the donation system. Thus, the item value determined in step 114 is the net value. Upon receiving a bid from the liquidator, the backend server may set the status of the transaction to “approved.”

The system may then determine an impact statement in step 116. To determine the impact statement, the system may use either the liquidator bid or a donor estimated value (provided by the donor) of the item. As discussed above, the impact statement is determined by comparing the value against metrics provided by the beneficiary. In particular, a beneficiary may provide the system with metrics detailing the cost of providing a unit of service in order for the system to calculate how the donor's item will provide benefits for the beneficiary. For example, Meals on Wheel is able to deliver a senior one meal of prepared food for $7.00. The unit is $7.00/meal. With this information, the system may then determine the total impact for the donated item. In other words, using the above metrics, a $700 value would provide an impact statement such as:

“Your donation can be converted to 100 warm meals delivered to seniors or hospice care patients.”

“You donated computer will provide a home-bound senior one year of warm meals delivered to their residence.”

Determining an impact statement based on an item's value is discussed above in reference to FIG. 1A.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the donor identification is complete, the system moves to accept the item in step 122. As part of the acceptance process, the system communicates with the donor and beneficiary about the item's acceptance as a donation in step 124. More specifically, the system communicates to the donor requirements for transfer of title to the liquidator. This communication may include packing and shipping instructions and a shipping label.

To complete the donation process, the donor then transfers title and possession of the item to the liquidator in step 128. If the system prepared packing and shipping instructions, the donor can simply use those to transfer the item to the liquidator. Upon receiving the item, the liquidator may communicate with the backend server to notify the backend server that the item has been received. The backend server may then set the status of the transaction to “transferred.” Once the liquidator receives the item, it converts the item to funds to donate to the beneficiary in step 126. For example, the liquidator may sell the item to a buyer. The funds are then transferred to the system to settle the funds in step 130 and 132. Once the liquidator has received funds for the item, the liquidator may communicate with the backend server to notify the backend server that the item is sold. The backend server may then set the status of the transaction to “sold.” While settlement usually occurs with transfer of funds, in some cases, fund transfer may occur after the settlement or the system may anticipate the funds that the liquidator will transfer and advance the amount to the benefactor before settlement. Once the liquidator transfers the funds to the benefactor, the backend server may then set the status of the transaction to “complete.” The system may then generate a 1098-C form, which is transmitted electronically (e.g., email, uploaded to the donor's account, and so forth) and/or mailed.

FIG. 1D illustrates the process of the integrated donation system of FIG. 1A specifically highlighting the process for handling lead generation fixed assets. For comparison, steps not needed for processing lead generated fixed assets have been removed. As discussed in FIG. 1A, donated items are classified as one of three types. One particular type is lead generation fixed assets 112. Lead generation fixed assets different from brokered fixed assets it is difficult for electronic liquidators to appropriately value lead generation fixed assets. Lead generation fix assets include real estate, business interest, securities, insurance, jewelry, commodity, and inventory. It may also include other assets associated with brokered fixed assets that are equally difficult to electronically value. For example, an automobile would normally be a brokered fixed asset but a classic automobile may be classified as lead generation fixed asset due to its uniqueness and the difficulty in identifying a market or resale potential.

Once an item is identified as a lead generation fixed asset, the system will proceed to determine a donor estimated value in step 113. For lead generation fixed assets, item valuation may be time consuming. In order to quickly process the asset and covert it to an amount, therefore encouraging donation, the system seeks a value for the item from the donor.

In some examples, the item description may be reviewed by another user (e.g., via the backend server) to determine whether the item is approved for donation. In some embodiments, the description examination and evaluation would be done electronically by matching the description provided by the donor to a database either local or remote from the system. For example, the item description may be parsed to identify keywords. The keywords from the item description may be compared with approved keywords (e.g., a whitelist) or non-approved keywords (e.g., a blacklist) in the database. If the item is not approved for donation, the donor may be notified and the transaction aborted.

Once the value is entered by the donor (and the item is approved for donation, if applicable), an impact statement is determined in step 116. As discussed above, the impact statement is determined by comparing a value against metrics provided by the beneficiary. For lead generation fixed assets, the system does not rely on a third-party bid for determining the value that is used in determining the impact statement. Instead, the system uses the donor estimated value. Determining an impact statement based on an item's value is discussed above in reference to FIG. 1A.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the donor information is obtained, the system sends a referral for a bid to a system that retrieves bids from potential buyers in step 120. The system (e.g., the backend server) may set the status identifier to “pending” for the transaction while waiting for bids. The potential buyer can examine the description of the item and take any needed action to identify the value of the item. In some embodiments, the description examination and evaluation by the potential buyer would be done electronically by matching the description provided by the donor to a database either local or remote from the system. The buyer then provides a bid to the system (e.g., the backend system and/or donor system) which is used to establish a value for the item. The bid offer may provide an instantaneous response from the donor or be delayed in an extended period of value determination and negotiation. Upon receiving a bid from a buyer, the backend server may set the status of the transaction to “approved.”

Once the final bid is determined, the buyer accepts the item and the system records the acceptance in step 122. The system then communicates to the donor the requirements for transferring title to the buyer in step 124. This communication is highly dependent on the item. For items that can be shipped, the system may include packing and shipping instructions and a shipping label. Additionally, the system may notify the benefactor of the donation and the amount of funds that will be transferred to the benefactor.

To complete the donation process, the donor then transfers title and possession of the item to the liquidator in step 128. If the system prepared packing and shipping instructions, the donor can simply use those to transfer the item to the liquidator. Once the liquidator receives the item, the backend server may then set the status of the transaction to “transferred.” The liquidator converts the item to funds to donate to the beneficiary in step 126. Upon receiving funds for the item, the backend server may then set the status of the transaction to “sold.” The funds are then transferred to the system to settle the funds in step 130 and 132. Once the funds are settled, the backend server may set the status of the transaction to “complete.” While settlement usually occurs with transfer of funds, in some cases, fund transfer may occur after the settlement or the system may anticipate the funds that the liquidator will transfer and advance the amount to the benefactor before settlement.

FIG. 1E illustrates expanded features of the process of the integrated donation system shown in FIG. 1A specifically directed to communication with parties to the donation. In particular, acceptance in step 122, no matter the item's classification, completes the necessary data to provide substantive communications to donor, the beneficiary, or and necessary reporting agencies. Once acceptance occurs, the system may proceed with a number of communication related steps. Communication may be in the form of an on-screen representation, electronic messaging, social media postings, or even a paper format.

For example, in step 134, the system provides a thank you message that includes an impact statement to the donor. The impact statement may be an automatically generated written statement, a graphical representation of the impact, or a combination of both. This communication may also suggest additional items from the same or different classes that can also be donated. This suggestion may be generated, in part, based on the beneficiary's, the donor's, or other donors' donation history in step 144.

For items that require shipment to be converted to funds, such as some brokered fixed assets and lead generation fixed assets, shipping labels and instructions may be communicated in step 136. These may be printed at the system or communicated to the donor's system to print at the donor's request.

In some cases, organizations or agencies may be notified of the donation in step 138. For example, donation information may need to be communicated to government agencies for filings such as taxes, title transfers. Other non-government entities may need to be notified for securities or corporate interest reporting.

In addition to the reporting in step 138, details of the donation may also be communicated to the benefactor in step 140. This communication may also include details about the system's process, timing of the item's conversion into actual funds, settlement, and anticipated timing of fund transfers. Finally, after the item is converted, physically transferred, or settled, the funds are transferred to the benefactor and the benefactor receives a communication that payment is complete in step 142.

The process described above in FIGS. 1A-1E are merely example embodiment and are not intended to limit the types of assets or the process by which assets may be converted into cash for donation to a benefactor.

FIG. 2 illustrates a process 200 for classifying an item to determine a particular processing path within the integrated donation system described in FIGS. 1A-E. As discussed above, the integrated donation system is designed to process at least three types of asset classes—cash equivalents 108, brokered fixed assets 110, and lead generation fixed assets 112. In some embodiments, once the system receives item description from the donor, the item is classified by comparing the description with an item database either local or remote to the system.

First, the item is compared against known cash equivalents in the database. Known cash equivalents include debit or debit card transactions, credit or credit card transactions, gift cards with a cash balance, electronic checks including any electronic payment such as automatic clearing house (ACH), and payments derived from other billings, such as a mobile phone bill. If the item meets any of the known cash equivalents, it may be classified and processed by the system as a cash equivalent. Although some items like gift cards may meet the description of cash equivalents, they may require reclassified to brokered fixed assets if converting the item to funds requires processing through a broker or liquidator.

Next, the item is compared against known brokered fixed assets in the database. Brokered fixed assets are those assets that are efficiently converted to funds through an automated or partially automated process by a third-party vendor contracted to provide instant bids on a group of pre-determined items. Known brokered fixed assets may include, for example, automobiles, boats, motorcycles, recreational vehicles, electronic devices, and virtual currency. The benefit with classifying an item as a brokered fixed asset is that the system can establish an instant value for the item in order to then calculate an impact statement.

Finally, items that do not fall into either the cash equivalent or brokered fixed asset classifications are classified by the system as lead generation fixed assets. Lead generation fixed assets may include, for example, real estate, business interest, securities, insurance, jewelry, commodities, and inventory. Generally speaking, though, lead generation fixed assets are different than brokered fixed assets because the system is unable to quickly obtain a third-party valuation. This may be due any number of reasons including, for example, government regulations, asset complexity, poor liquidity, rarity, etc. Despite these valuation challenges, though, the system continues the donation process by obtaining an initial value from the donor.

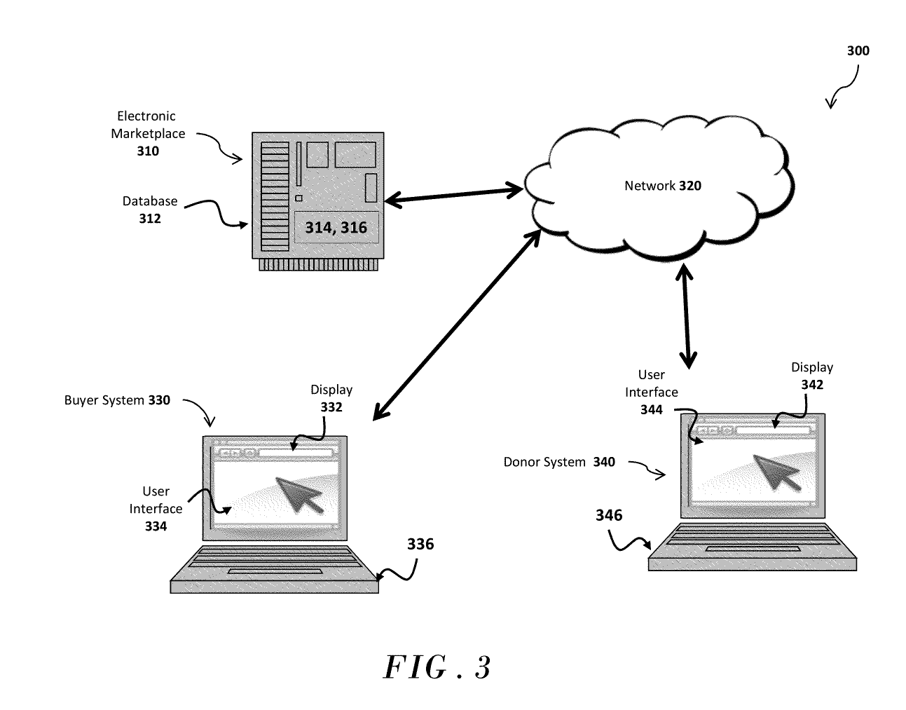

FIG. 3 illustrates an example computer system 300 that may be used to carry out the process of the integrated donation system described in FIGS. 1A-E and 2. System 300 includes an electronic marketplace system 310, a buyer system 330, and a donor system 340. These systems are connected via a network 320 such as, for example, the Internet. Electronic marketplace 310 may be the system for processing donations describe in FIGS. 1A-E and 2 and may also be referred to as a backend server. Marketplace 310 includes a one or more computer processors 314, memory 316, and may include a database 312 for storing item classification information. Buyer system 330 and donor system 340 include and number of computer devices such as, for example, mobile computers, personal computers, personal digital assistants, smart phones, tablets, laptops, wearable computers, ultra-mobile personal computers, enterprise digital assistants, electronic book readers, minicomputers, mainframes, servers, workstations, minicomputers, microcomputers, desktop computer, clones and terminals.

In some embodiments, to conduct the process described in FIGS. 1A-E and 2, the donor begins by transmitting personal data via donor system 340 to the electronic marketplace 310 to establish an account. The account may include information about the donor such as name, address, government identification information, preferred benefactors, donation history, and item search history. This list is not exclusive and is not intended to limit the embodiments.

The buyer may also transmit personal information via buyer system 330 to create an account. The buyer's information may include information listed above for a donor's account as well as additional information such as, for example, shipping information and payment information. As discussed above in FIGS. 1C-D, when a donor proceeds with a transaction at the electronic marketplace 310 that requires a buyer, the buyer may receive notification of the item for sale via buyer system 330. In some embodiments, the buyer may provide the system with a wish list (e.g., a list of assets or types of assets) so that the buyer is notified only about items that the buyer is interested in. In this case, the buyer will only be notified when a broker fixed asset or lead generation fixed asset matching its requirements is available for purchase. From the buyer system 330, the buyer can examine the description of items. In a preferred embodiment, the description examination is done electronically at the buyer system 330 by matching the description generated by the donor to a database local or remote to buyer system 330. The buyer may then purchase the item, whereby the necessary transaction information is transmitted from buyer system 330 to the electronic marketplace 310.

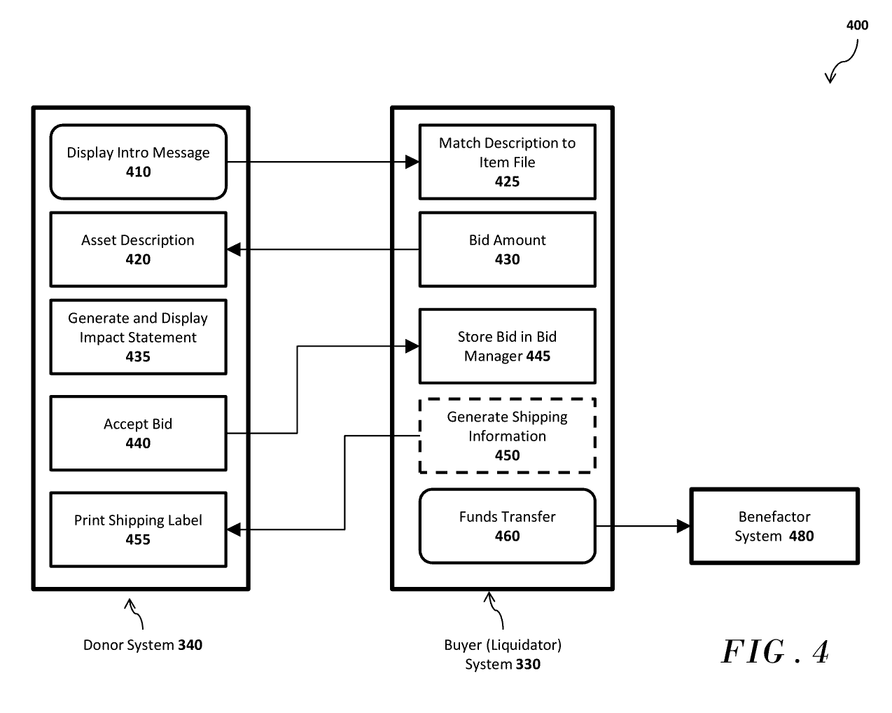

FIG. 4 illustrates an example process 400 between donor system 340, buyer system 330, and benefactor system 480. As described above in reference to FIGS. 1A-E, 2 and 3, these process steps may take place at an electronic marketplace system.

Process 400 begins in step 410. Step 410 includes soliciting asset donations from a donor via donor system 340. Typically, a web page associated with a benefactor may explain the goals of the benefactor, their successes, the global impact, or specific impacts to individuals served. In some embodiments, in order to invite a potential donor to make a donation, an introductory message is displayed inviting participation. The message would alternatively or collectively explain the outcome of the donation, display images showing the resulting impact of the donation (e.g., an impact statement), basic instructions to complete the form, pop-up detailed help, audio files, video files, or other instructional material.

Following the solicitation step 410, the potential donor enters an asset description to begin the process of receiving an individualized impact statement in step 420. Entering of the specific item description can be performed using a number of methods discussed above. For example, the donor may enter an alphanumeric asset description 52 such as “See 52 LCD TV.” This may be done through donor system 340 by typing a description, selecting a specific asset from a drop down list, or a combination of both a keyed description and a drop down list. In other words, a donor may begin typing “See” and be provided an instantaneous drop down list of selections, such as:

See 30 LED Television

See 32 LCD Television

See 32 LCD Monitor

See 40 Monitor with Antenna

See 52 LCD Television

The prospective donor would then select a particular asset from the resulting search list. Alternatively, the item description may be entered using an index that could be keyed-in or scanned such as a UPC.

Once entered, the item description is transmitted to the buyer system 330 and matched to a description provided by the buyer system 330. The buyer system 330 may then retrieve an associated bid amount in step 430. The bid amount includes a transaction identifier, an asset description, an amount or value. The bid amount is transmitted to the donor system 310 to prepare an impact statement to display to the prospective donor. The impact statement is then generated and displayed to the perspective donor in step 435 to encourage the prospective donor to continue with the asset donation. If the prospective donor accepts the bid amount in step 440. In some embodiments, the donor may not be shown the actual bid amount. Instead, the donor may accept, or approve, bid based only on the impact statement. In this case, the donor may select multiple impact statements or only a single impact statement.

Once the bid amount is accepted, the acceptance is transferred to the buyer system 330 and stored in step 445. In response to the bid acceptance, the buyer system 330 may generate shipping information in step 450 for those assets that can be shipped. The shipping information may then be transmitted to the donor system 330 for printing by the donor in step 455. The buyer system 330 may also email the shipping information to the donor or print and then ship the information to the donor. The shipping information may include packing and shipping materials to assist in the efficient transfer of the item.

Finally, the buyer system 330 transfers funds to the benefactor system 480 in step 460. The benefactor system 480 may be a server managed by a benefactor, a server managed by a third-party on behalf of the benefactor, a banking institution designated to receive the funds, or a third-party designated to convert the funds into the promised impact.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In the foregoing description, and the following claims, method steps and/or actions are described in a particular order for the purposes of illustration. It should be appreciated that in alternate embodiments, the method steps and/or actions may be performed in a different order than that described. Additionally, the methods described above may be embodied in machine-executable instructions stored on one or more machine-readable mediums, such as disk drives, thumb drives or CD-ROMs. The instructions may be used to cause the machine (e.g., computer processor) programmed with the instructions to perform the method. Alternatively, the methods may be performed by a combination of hardware and software. While illustrative and presently preferred embodiments have been described in detail herein, it is to be understood that the inventive concepts may be otherwise variously embodied and employed, and that the appended claims are intended to be construed to include such variations, except as limited by the prior art.

What is claimed is:

1. An electronic market place computer system for facilitating donation of a monetary amount to one or more benefactors, comprising:
at least one computer processor electronically coupled to memory, the processor configured to carry out the following process stored as instructions in memory:
receive an item description from a donor device that describes an item that a donor intends to be converted to a monetary amount, wherein the monetary amount is to be provided to the benefactor;
receive benefactor identification data, wherein the benefactor identification data indicates at least one benefactor that the donor intents to make a donation to, and wherein the benefactor identification data is associated with the donor;
associate, in one or more databases, the item description with a unique transaction identifier, a status identifier and a designation identifier,
wherein the status identifier is initially set to a first status, and
wherein the designation identifier corresponds to the benefactor identification data;
match the item description with a corresponding description stored in a database, wherein the corresponding description is associated with an asset classification, the asset classification indicating a particular method for converting the item to the monetary amount;
determine a value for the item;
provide the value to the donor device;
receive an acceptance command from the donor device, wherein the acceptance command indicates the donor's intent to donate the monetary amount indicated by the value;
based on receiving the acceptance command, convert the item into the monetary amount indicated by the value;
transfer funds corresponding to the monetary amount to one or more benefactors based on the designation identifier; and
after transferring the funds, update the status identifier to a second status.

2. The system of claim 1, wherein the asset classification is at least one of: a cash equivalent, a brokered fixed asset, and a lead generation fixed asset.

3. The system of claim 1, wherein determining the value comprises:
updating the status identifier to a third status;
after updating the status identifier to the third status, providing the item description to one or more electronic liquidator systems;
receiving a bid amount from the one or more electronic liquidator systems, wherein the bid amount is designated as the value; and
after receiving the bid amount, updating the status identifier to a fourth status.

4. The system of claim 3, wherein converting the item into the monetary amount includes:
providing instructions to the donor via the donor device to transfer the item to an entity designated by the liquidator system;
updating the status identifier to indicate that the item has been transferred from the donor;
receiving the monetary amount indicated by the value from the entity designated by the liquidator system; and
updating the status identifier to indicate that the monetary amount has been received for the item.

5. The system of claim 1, further comprising:
associating, by at least one computer processor, the item description with a frequency, wherein the frequency indicates that the item is a re-occurring donation; and
based on the frequency, scheduling one or more withdrawals from an account corresponding to the donor; and
based on the scheduling, processing the one or more withdrawals from the account.

6. The system of claim 1, wherein determining the value comprises:
receiving an estimated value corresponding to the item from the donor via the donor device, wherein the estimated value is designated as the value.

7. The system of claim 6, wherein converting the item into the monetary amount includes:
withdrawing the value from an account corresponding to the donor.

8. The system of claim 1, determining, based upon one or more keywords in the item description, whether to refer the item to an auction house or to a retail network, wherein the keywords correspond to at least one of: a vehicle mileage and a vehicle model year. .

9. The system of claim 1, wherein providing the value to the donor device includes:
generating, by at least one computer processor, a one or more impact statements, wherein the impact statements are based on the value and one or metrics provided by one or more benefactors; and
providing the one or more impact statements to the donor device.

10. A computer-implemented method for donating to a benefactor, the method comprising:
receiving, by at least one computer processor, a description of an item from a donor device;
associating, using one or more databases, the description of the item with a unique transaction identifier, a status identifier and a designation identifier,
wherein the status identifier is updated to indicate one or more of the following statuses during a transaction to donate the item: the item is awaiting one or more bids, the one or more bids have been received for the item, the item has been transferred from the donor, funds have been received for the item, and the transaction has been completed, and
wherein the designation identifier corresponds to one or more benefactors;
matching, by at least one computer processor, the description of the item with a corresponding description stored in a database, wherein the corresponding description is associated with an asset classification, the asset classification indicating a particular method for processing a transaction corresponding to the item;
determining, by at least one computer processor, a value corresponding to the item;
receiving, by at least one computer processor, an acceptance command from the donor device, wherein the acceptance command indicates a donor's intent to donate the item;
after receiving the acceptance command, converting, by at least one computer processor, the item into the value;
transferring to the one or more benefactors, by at least one computer processor, a monetary amount corresponding to the value; and
updating the status identifier to indicate that the transaction has been completed.

11. The method of claim 10, wherein the asset classification is at least one of: a cash equivalent, a brokered fixed asset, and a lead generation fixed asset.

12. The method of claim 10, further comprising:
associating, by at least one computer processor, the description of the item with a frequency, wherein the frequency indicates that the item is a re-occurring donation; and
based on the frequency, scheduling one or more withdrawals from an account corresponding to the donor; and
based on the scheduling, processing the one or more withdrawals from the account.

13. The method of claim 10, wherein determining the value comprises:
updating the status identifier to indicate that the item is awaiting a bid;
providing the item description to one or more electronic liquidator systems;
receiving the bid from the one or more electronic liquidator systems, wherein a bid amount corresponding to the bid is designated as the value; and
updating the status identifier to indicate that the bid has been received for the item;
wherein converting the item into the value comprises:
providing instructions to the donor via the donor device to transfer the item to an entity designated by the liquidator system;
updating the status identifier to indicate that the item has been transferred from the donor;
receiving the value from the entity designated by the one or more liquidator systems; and
updating the status identifier to indicate that the value has been received for the item.

14. The method of claim 10, further comprising:
sending an electronic communication to the donor device each time the status identifier is updated.

15. The method of claim 10, wherein determining the value comprises:
receiving an estimated value corresponding to the item from the donor via the donor device, wherein the estimated value is designated as the value.

16. The method of claim 15, wherein converting the item into the value comprises:
withdrawing the value from an account corresponding to the donor.

17. The method of claim 10, further comprising:
determining, based upon one or more keywords in the description of the item, whether to refer the item to an auction house or to a retail network, wherein the keywords correspond to at least one of: a vehicle mileage and a vehicle model year.

18. The method of claim 10, further comprising:
generating, by at least one computer processor, a one or more impact statements, wherein the one or more impact statements are based on one or metrics provided by the one or more benefactors and at least one of: (1) an estimated value provided by the donor device and (2) a bid amount received from one or more electronic liquidator systems; and
providing, by at least one computer processor, the one or more impact statements to the donor device.

19. An electronic market place computer system for facilitating donation of a monetary amount to one or more benefactors, comprising:
at least one computer processor electronically coupled to memory, the processor configured to carry out the following process stored as instructions in memory:
receive identification data and preference data from a donor device that identifies a donor;
store the identification data and the preference data in one or more databases such that the data is associated with the donor;
receive an item description from the client device that describes an item that the donor intends to be converted to a monetary amount, wherein the monetary amount is to be provided to the benefactor;
receive benefactor identification data, wherein the benefactor identification data indicates at least one benefactor that the donor intents to make a donation to, and wherein the benefactor identification data is associated with the donor.
match the item description with a corresponding description stored in a database, wherein the corresponding description is associated with an asset classification, the asset classification indicating a particular method for converting the item to the monetary amount;
determine a value for the item, wherein the value is determined, at least in part, based on the asset classification;
provide the value to the donor device;
receive an acceptance command from the donor device, wherein the acceptance command indicates the donor's intent to donate the monetary amount indicated by the value;
based on receiving the acceptance command, convert the item into the monetary amount indicated by the value; and
transfer the monetary amount to one or more benefactors based on the benefactor identification data.

20. The system of claim 19, further comprising:
generating, by at least one computer processor, a one or more impact statements, wherein the impact statements are based on the value and one or metrics provided by one or more benefactors based on the benefactor identification data; and
providing the one or more impact statements to the donor device.

21. The system of claim 19, wherein determining the value for the item includes:
providing the item description to one or more electronic liquidator systems; and
receiving a bid amount from the one or more electronic liquidator systems, wherein the bid amount is designated as the value for the item.

22. The system of claim 21, wherein converting the item into the monetary amount includes:
providing instructions to the donor via the donor device to transfer the item to an entity designated by the liquidator system; and
receiving the monetary amount indicated by the value from the entity designated by the liquidator system.

23. The system of claim 22, wherein transferring the monetary amount to one or more benefactors includes:
transferring the monetary amount to the one or more benefactors prior to receiving the monetary amount from the entity designated by the liquidator system.

24. The system of claim 19, wherein determining the value for the item includes:
receiving the value of the item from the donor via the donor device;
providing the item description and the value to one or more liquidator systems;
receiving a negotiated value from at least one of the one or more liquidator systems, wherein the negotiated value is designated as the value for the item.

25. The system of claim 24, wherein converting the item into the monetary amount includes:
providing instructions to the donor via the donor device to transfer the item to an entity designated by the liquidator system; and
receiving the monetary amount indicated by the value from the entity designated by the liquidator system.

26. The system of claim 25, wherein transferring the monetary amount to one or more benefactors includes:
transferring the monetary amount to the one or more benefactors prior to receiving the monetary amount from the entity designated by the liquidator system.

27. The system of claim 21, wherein providing the value to the donor device includes:
generating, by at least one computer processor, a one or more impact statements, wherein the impact statements are based on the value and one or metrics provided by one or more benefactors based on the benefactor identification data; and
providing the one or more impact statements to the donor device as the value.
